(19) United States
(12) Patent Application Publication
(10) Pub. No.: US 2019/0193712 A1
(43) Pub. Date: Jun. 27, 2019

(54) VEHICLE INTERIOR ENVIRONMENT ADJUSTMENT DEVICE, STORAGE MEDIUM STORING PROGRAM, AND VEHICLE INTERIOR ENVIRONMENT ADJUSTMENT SYSTEM

(71) Applicant: Toyota Jidosha Kabushiki Kaisha, Toyota-shi Aichi-ken (JP)

(72) Inventors: Daichi Kusanagi, Toyota-shi Aichi-ken (JP); Masaki Ito, Toyota-shi Aichi-ken (JP); Kenta Miyahara, Toyota-shi Aichi-ken (JP); Kihiro Kato, Tokoname-shi Aichi-ken (JP); Yuka Shidochi, Toyota-shi Aichi-ken (JP); Yohei Tanigawa, Toyota-shi Aichi-ken (JP)

(21) Appl. No.: 16/225,965

(22) Filed: Dec. 19, 2018

(30) Foreign Application Priority Data
Dec. 27, 2017 (JP) 2017-251919

(51) Int. Cl. B60W 10/30; B60H 1/00; B60Q 3/80; G06Q 50/00; G06F 16/953; G06F 17/27

(52) U.S. Cl. CPC B60W 10/30; B60H 1/00735; B60Q 3/80; B60Q 2500/20; G06F 16/953; G06F 17/2785; G06Q 50/01

(57) ABSTRACT

There is provided a vehicle interior environment adjustment device including: a first memory; and a first processor connected to the first memory, wherein the first processor: acquires posted information, posted by a specific user, from a management server configured to manage a social networking service (SNS), determines a mode of a vehicle interior environment of a vehicle in which the specific user rides, from a characteristic of the specific user based on the acquired posted information, and outputs a control signal according to the determined mode.

### CROSS-REFERENCE TO RELATED APPLICATION

This application is based on and claims priority under 35 USC 119 from Japanese Patent Application No. 2017-251919 filed on Dec. 27, 2017, the disclosure of which is incorporated by reference herein.

### BACKGROUND

### Technical Field

The present disclosure relates to a vehicle interior environment adjustment device, a storage medium storing a program, and a vehicle interior environment adjustment system.

### Related Art

In recent years, with the spread of mobile terminals such as smartphones and tablet terminals, social networking services (hereinafter collectively referred to as SNSs) such as LINE (registered trademark), Twitter (registered trademark), Facebook (registered trademark), and Instagram (registered trademark) have been frequently used.

The posted information of the SNS may also be used in an in-vehicle device such as a car navigation device. For example, Japanese Patent No. 5943222 discloses a technique of acquiring posted information of the SNS relating to positional information and displaying the acquired information together with map information. According to the in-vehicle device, occupants of the vehicle can obtain useful information while moving.

Here, the in-vehicle device described in Japanese Patent No. 5941227 processes the posted information of the SNS to reflect the processed posted information on the map, and there is no difference in providing the posted information of the SNS to the occupant of the vehicle.

On the other hand, if the characteristics such as emotion, physical condition, and attribute of the occupant can be grasped from the posted information of the SNS, the use of the posted information of the SNS will be expanded beyond providing information.

### SUMMARY

Based on the above points, the present disclosure has an object to provide a vehicle interior environment comfortable for occupants by using the posted information of the SNS.

According to a first aspect of the present disclosure, there is provided a vehicle interior environment adjustment device, which includes: a first memory; and a first processor connected to the first memory, wherein the first processor acquires posted information, posted by a specific user, from a management server configured to manage a social networking service (SNS), determines a mode of a vehicle interior environment of a vehicle in which the specific user rides, from a characteristic of the specific user based on the acquired posted information, and outputs a control signal according to the determined mode.

The vehicle interior environment adjustment device according to the first aspect acquires posted information in the SNS of a specific user and reflects the characteristic of the specific user based on the acquired posted information in the vehicle interior environment of the vehicle in which the specific user rides. Here, the “characteristic” related to the user includes emotion, physical condition, attributes, and the like. In addition, the “vehicle interior environment” is an element that can be adjusted in a vehicle, and includes music played in the vehicle interior, scent pervading the vehicle interior, and lighting illuminating the vehicle interior. Furthermore, the “mode” related to the vehicle interior environment refers to a condition that can be adjusted as the vehicle interior environment. For example, when music is used as an element, the tunes and sound volumes correspond to the mode, when scent is used as an element, the type of scent corresponds to the mode, and when lighting is used as an element, the lighting color and illumination correspond to the mode. According to the vehicle interior environment adjustment device, it is possible to provide a vehicle interior environment comfortable for occupants by using posted information of the SNS.

According to a second aspect of the present disclosure, there is provided a vehicle interior environment adjustment device, the first processor classifies, by type, the characteristic of the specific user from the acquired posted information, and determines the mode based on the classified type.

According to the vehicle interior environment adjustment device of the second aspect, classifying the characteristic of a specific user allows the vehicle interior environment to be easily adjusted.

According to a third aspect of the present disclosure, there is provided a vehicle interior environment adjustment device, the posted information is text information, and when the text information includes a phrase related to each type, the first processor classifies a type corresponding to the phrase as the characteristic of the specific user, and determines the mode based on the classified type.

According to the vehicle interior environment adjustment device of the third aspect, acquiring text information posted on the SNS and comparing the text information with the phrase set for each type of the characteristic allows the characteristic of the specific user to be easily classified.

According to a fourth aspect of the present disclosure, there is provided a vehicle interior environment adjustment device, in the first processor, the mode corresponding to the type is set by the specific user.

According to the vehicle interior environment adjustment device of the fourth aspect, it is possible to reflect the preference of a specific user in the vehicle interior environment.

According to a fifth aspect of the present disclosure, there is provided a storage medium, which stores a program for causing, a first processor to execute interior environment adjustment processing, the interior environment adjustment processing including: acquiring posted information, posted by a specific user, from a management server configured to manage a social networking service (SNS); determining a mode of a vehicle interior environment of a vehicle in which the specific user rides, from a characteristic of the specific user based on the acquired posted information; and outputting a control signal according to the determined mode.

According to the storage medium of the fifth aspect, it is possible to provide a vehicle interior environment comfortable for occupants by using posted information of the SNS.

According to a sixth aspect of the present disclosure, there is provided a vehicle interior environment adjustment system, which includes: the vehicle interior environment adjustment device according to any one of aspects 1 to 4; and a vehicle configured to receive the control signal from the vehicle interior environment adjustment device. The vehicle includes: an adjustment device configured to adjust the vehicle interior environment, a second memory and a second processor connected to the second memory. The second processor controls the adjustment device based on the control signal acquired from the vehicle interior environment adjustment device.

According to the vehicle interior environment adjustment system of the sixth aspect, it is possible to provide a vehicle interior environment comfortable for occupants by using posted information of the SNS.

According to a seventh aspect of the present disclosure, there is provided a vehicle interior environment adjustment system, which includes: the vehicle interior environment adjustment device according to any one of aspects 1 to 4; a mobile terminal registered in the vehicle interior environment adjustment device; and a vehicle configured to receive the control signal from the vehicle interior environment adjustment device. The vehicle includes: an adjustment device configured to adjust the vehicle interior environment, and a control device configured to control the adjustment device. The control device includes: a second memory, and a second processor connected to the second memory. The first processor transmits the control signal toward the control device when the mobile terminal is present in a vehicle interior of the vehicle, and the second processor controls the adjustment device based on the control signal acquired from the vehicle interior environment adjustment device.

According to the vehicle interior environment adjustment system of the seventh aspect, it is possible to adjust the vehicle interior environment at the timing when a specific user holding the mobile terminal rides in the vehicle.

According to the present disclosure, it is possible to provide a vehicle interior environment comfortable for occupants by using posted information of the SNS.

### BRIEF DESCRIPTION OF THE DRAWINGS

Exemplary embodiments of the present disclosure will be described in detail based on the following figures, wherein:

FIG. 1 is a block diagram showing a configuration of a vehicle interior environment adjustment system according to first and second embodiments;

FIG. 2A is a block diagram showing a configuration of a center server according to the first and second embodiments;

FIG. 2B is a block diagram showing a hardware configuration of the center server;

FIG. 3 is a diagram showing an example of an environment table according to the embodiment;

FIG. 4A is a diagram showing an example of a first control table according to the embodiment;

FIG. 4B is a diagram showing an example of a second control table according to the embodiment;

FIG. 4C is a diagram showing an example of a third control table according to the embodiment;

FIG. 5A is a block diagram showing a configuration of a vehicle control device and an adjustment device according to the first and second embodiments;

FIG. 5B is a block diagram showing a hardware configuration of the vehicle control device;

FIG. 6 is a sequence diagram showing a flow of processing relating to user registration in the vehicle interior environment adjustment system according to the first and second embodiments;

FIG. 7 is a sequence diagram showing a flow relating to processing when vehicle interior environment in the vehicle interior environment adjustment system according to the first embodiment is adjusted;

FIG. 8 is a flowchart showing a flow of emotion analysis processing according to the embodiment;

FIG. 9 is a flowchart showing a flow of environment adjustment processing according to the embodiment;

FIG. 10 is a diagram showing a dialog screen between a center server and a specific user in a vehicle interior environment adjustment system according to a second embodiment;

FIG. 11 is a sequence diagram showing a flow relating to processing when vehicle interior environment in the vehicle interior environment adjustment system according to the second embodiment is adjusted;

FIG. 12 is a block diagram showing a configuration of a vehicle interior environment adjustment system according to a third embodiment; and

FIG. 13 is a block diagram showing a configuration of a vehicle control device and an adjustment device according to the third embodiment.

### DETAILED DESCRIPTION

### First Embodiment

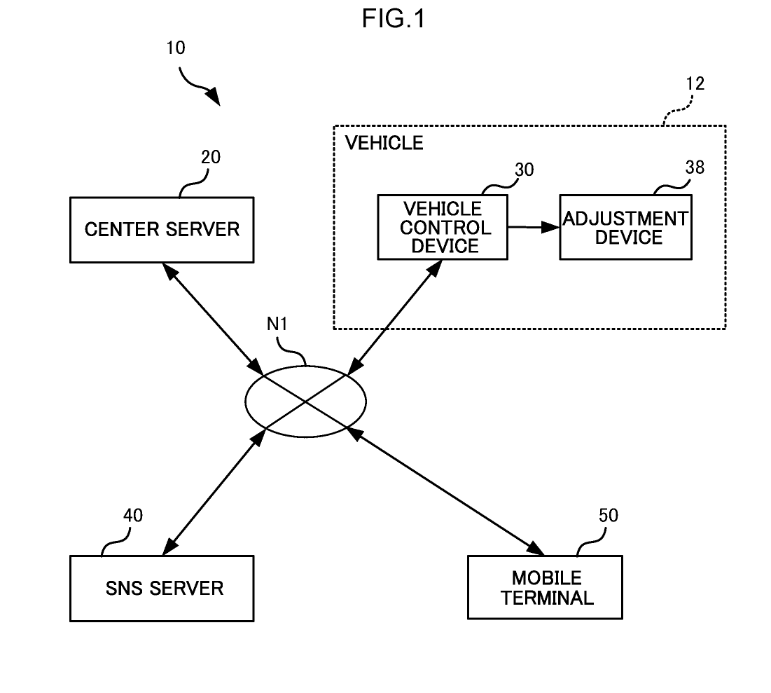

Hereinafter, a vehicle interior environment adjustment device and a vehicle interior environment adjustment system according to an embodiment of the present disclosure will be described with reference to the drawings. FIG. 1 is a block diagram showing a schematic configuration of a vehicle interior environment adjustment system 10 according to the present embodiment.

### Configuration

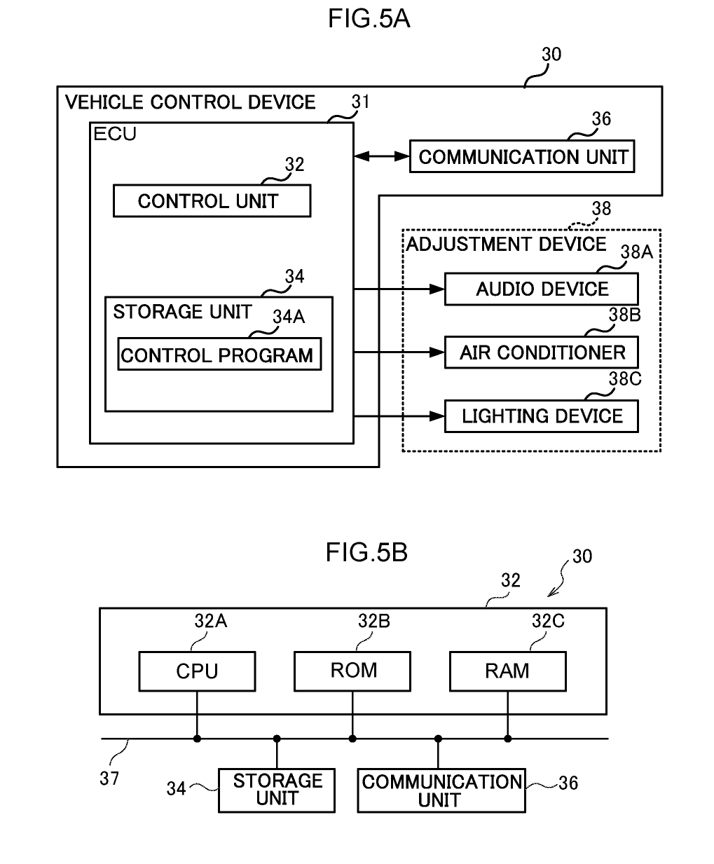

As shown in FIG. 1, the vehicle interior environment adjustment system 10 according to the present embodiment includes a vehicle 12, a center server 20, an SNS server 40, and a mobile terminal 50. In addition, the vehicle 12 includes a vehicle control device 30 and an adjustment device 38. The adjustment device 38 includes an audio device 38A, an air conditioner 38B, and a lighting device 38C (see FIG. 5A). The center server 20, the SNS server 40, the mobile terminal 50, and the vehicle control device 30 are connected to each other via a network N1.

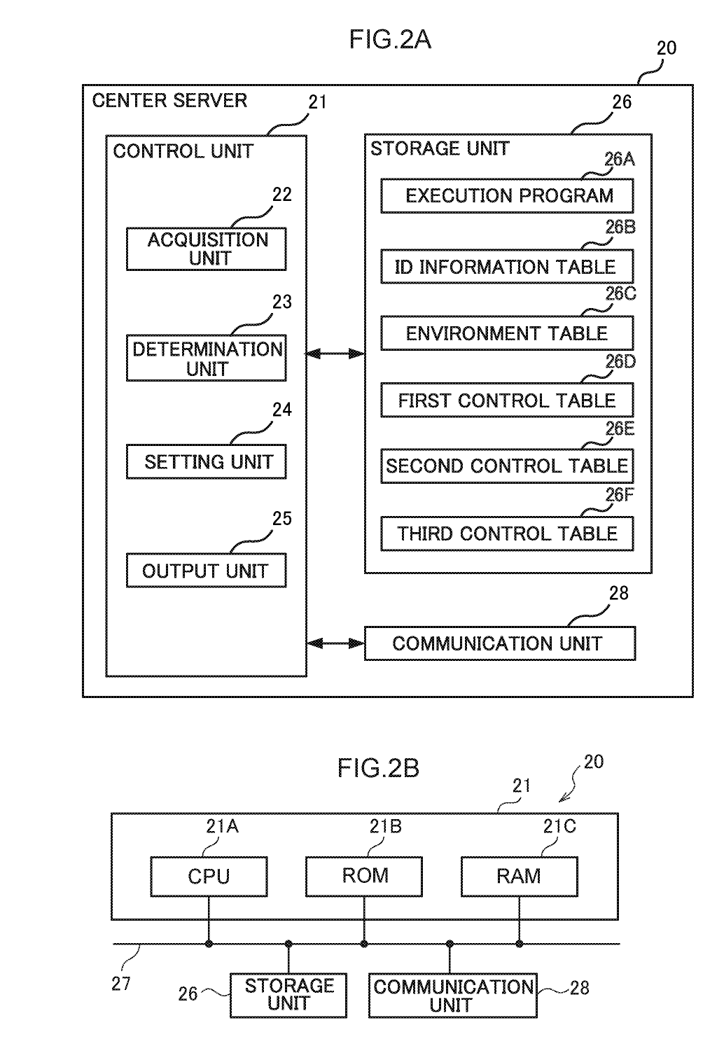

As shown in FIG. 2A, the center server 20 includes a control unit 21, a storage unit 26, and a communication unit 28. The center server 20 of the present embodiment executes interior environment adjustment processing. Specifically, the center server 20 acquires posted information of a specific user from the SNS server 40, and analyzes the characteristic of the specific user based on the acquired posted information. In addition, the center server 20 determines the mode of the vehicle interior environment based on the analyzed characteristics, and outputs the control signal according to the mode toward a vehicle 12 in which the specific user rides (see FIG. 1). That is, in the vehicle 12, the specific user is an occupant. In the present embodiment, the center server 20 corresponds to a vehicle interior environment adjustment device.

As shown in FIG. 2B, the control unit 21 includes a central processing unit (CPU) 21A, a read only memory (ROM) 21B, and a random access memory (RAM) 21C. The CPU 21A, the ROM 21B, the RAM 21C, the storage unit 26, and the communication unit 28 are communicably connected to each other via the bus 27. The CPU 21A corresponds to a first processor, and the RAM 21C corresponds to a first memory. In the control unit 21, the CPU 21A reads an execution program 26A to be described below from the storage unit 26, and executes the execution program 26A with the RAM 21C as a work area. Thus, in the control unit 21, the CPU 21A functions as the acquisition unit 22, the determination unit 23, the setting unit 24, and the output unit 25.

As shown in FIG. 2A, the acquisition unit 22 has a function of acquiring text information according to posting of a specific user from the SNS server 40 via the communication unit 28. The acquired text information is used to classify emotions in the determination unit 23 to be described below.

The determination unit 23 has a function of determining a mode of the vehicle interior environment in the vehicle 12 in which the specific user rides. Here, in the present embodiment, the “vehicle interior environment” is an adjustable element in the vehicle 12, and includes music played in the vehicle interior, scent pervading the vehicle interior, and lighting illuminating the vehicle interior. It should be noted that the vehicle interior environment is not limited to these. For example, as a vehicle interior environment, temperature and humidity in the vehicle interior, display patterns and display colors of a meter panel, seat positions and seat arrangements, and the like may be adjustable elements in the vehicle 12. In addition, the “mode” related to the vehicle interior environment refers to a condition that is adjustable as the vehicle interior environment. For example, when music is used as an element, the tunes and sound volumes correspond to the mode; when scent is used as an element, the type of scent corresponds to the mode; and when lighting is used as an element, the lighting color and illumination correspond to the mode.

The setting unit 24 has a function of setting the mode of the vehicle interior environment corresponding to the characteristic of the specific user. This setting method is described below.

The output unit 25 has a function of outputting a control signal according to the mode of the vehicle interior environment determined by the determination unit 23. The control signal output from the output unit 25 is transmitted from the communication unit 28 toward the vehicle control device 30.

As the storage unit 26, for example, a non-transitory storage medium such as a hard disk drive (HDD), a solid state drive (SSD), or a flash memory, is used. The storage unit 26 of the present embodiment stores an execution program 26A for executing various kinds of processing in the center server 20. In addition, the storage unit 26 stores an ID information table 26B, an environment table 26C, a first control table 26D, a second control table 26E, and a third control table 26F. The ID information table 26B stores an account and a password necessary for viewing posts of the specific user in the SNS server 40, a terminal-specific ID for specifying the vehicle control device 30, a terminal-specific ID for specifying the mobile terminal 50, and the like.

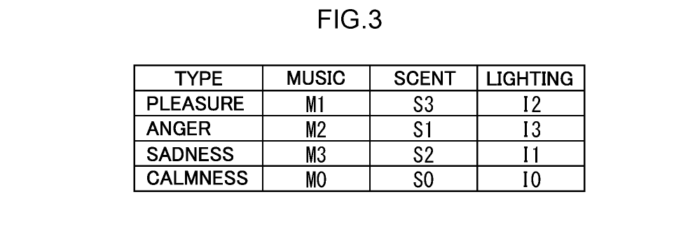

In the environment table 26C, a music setting number, a scent setting number, and a lighting setting number are defined for each type of emotion that is a characteristic of a specific user. FIG. 3 shows an example of the environment table 26C. As shown in FIG. 3, in the environment table 26C, the characteristics of a specific user are classified as four types “pleasure” expressing an emotion of pleasure, “anger” expressing an emotion of anger, “sadness” expressing an emotion of sadness, and “calmness” expressing an emotion of calmness. Then, in the environment table 26C, setting numbers of music, scent, and lighting are defined for each type. Here, the symbols M0 to M3 denote music setting, numbers the symbols S0 to S3 mean scent setting numbers, and the symbols I0 to I3 denote lighting setting numbers.

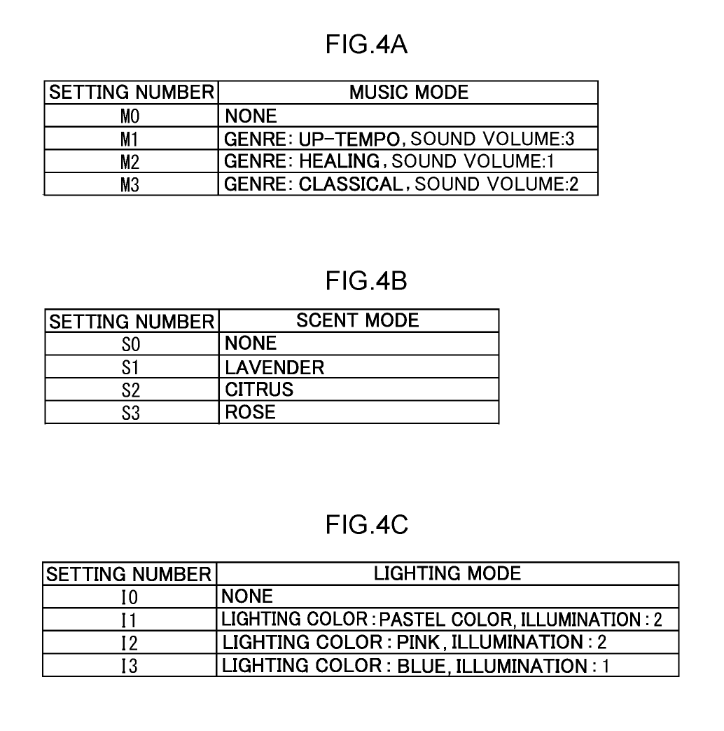

Further, the music mode is defined for each setting number in the first control table 26D, the scent mode is defined for each setting number in the second control table 26E, and the lighting mode is defined for each setting number in the third control table 26F. As shown in FIG. 4A, in the first control table 26D, the tune genre and the sound volume are defined as the mode of the music adjusted in the audio device 38A with respect to the music setting number. In addition, as shown in FIG. 4B, in the second control table 26E, the type of scent is defined as the mode of the scent adjusted in the air conditioner 38B with respect to the scent setting number. Furthermore, as shown in FIG. 4C, in the third control table 26F, lighting color and illumination are defined. as the mode of the lighting adjusted in the lighting device 38C with respect to the lighting setting number.

The communication unit 28, which is a communication interface, is connected to the network N1 (see FIG. 1). The communication unit 28 has a function of communicating with each of the SNS server 40, the vehicle control device 30, and the mobile terminal 50. Here, as the network N1, for example, the Internet, a wide area network (WAN), or the like, is applied.

As shown in FIG. 5A, the vehicle control device 30, which is a control device in the vehicle 12, includes an ECU 31 and a communication unit 36. Based on the control signal received from the center server 20, the vehicle control device 30 controls each device configuring the adjustment device 38, so as to adjust the vehicle interior environment.

As shown in FIG. 5B, the ECU 31 includes a microcomputer including a central processing unit (CPU) 32A, a read only memory (ROM) 32B, a random access memory (RAM) 32C, and the like. The ECU 31 includes a control unit 32 including a CPU 32A and a storage unit 34 including another ROM. The CPU 32A, the ROM 32B, the RAM 32C, the storage unit 34, and the communication unit 36 are communicably connected to each other via the bus 37. The CPU 32A corresponds to a second processor, and the RAM 32C corresponds to a second memory. The control unit 32 has a function of controlling each device configuring the adjustment device 38.

Further, as shown in FIG. 5A, the storage unit 34 of the present embodiment stores a control program 34A for executing various kinds of processing in the vehicle control device 30. In the present embodiment, the CPU 32A reads the control program 34A from the storage unit 34 and executes the control program 34A with the RAM 32C as a work area. Thus, in the control unit 32, the CPU 32A executes various kinds of processing.

The communication unit 36, which is a communication interface, is connected to the network N1 (see FIG. 1). The communication unit 36 has a function of communicating with the center server 20. That is, the control signal transmitted from the communication unit 28 of the center server 20 is received at the communication unit 36.

As shown in FIGS. 1 and 5A, the vehicle control device 30 (ECU 31) is electrically connected to the adjustment device 38, As described above, the adjustment device 38 includes an audio device 38A, an air conditioner 38B, and a lighting device 38C. Here, the audio device 38A is a device that adjusts music, which is one of the elements of the vehicle interior environment. In the present embodiment, changing the time and the sound volume output from the audio device 38A adjusts the music played in the vehicle interior. In addition, the air conditioner 38B is a device for adjusting scent, which is one of the elements of the vehicle interior environment. In the present embodiment, changing the type of fragrance installed in the air passage of the air conditioner 38B adjusts the scent pervading the vehicle interior. Furthermore, the lighting device 38C is a device for adjusting lighting, which is one of the elements of the vehicle interior environment. In the present embodiment, changing the lighting color and the illumination in the lighting device 38C, such as a room light, adjusts the light for illuminating the vehicle interior.

The SNS server 40 of the present embodiment has a function as a management server for managing the SNS. As shown in FIG. 1, the SNS server 40 is connected to the center server 20 and the mobile terminal 50 via the network N1. In the SNS server 40, making posted information of a specific user transmitted from the mobile terminal 50 or the like transmittable (that is, uploading) allows another terminal connected to the SNS server 40 to receive the posted information (that is, downloading). In this SNS server 40, browsing restriction can be applied so that only users specified by a specific user can browse posting by the specific user.

The mobile terminal 50 is a smartphone or a tablet terminal possessed by a specific user using the SNS. The mobile terminal 50 is connected to the center server 20 and the SNS server 40 via the network N1. A specific user using the vehicle interior environment adjustment system 10 of the present embodiment can post a message to the SNS from the mobile terminal 50 and can set vehicle interior environment from the mobile terminal 50.

### Flow of Processing

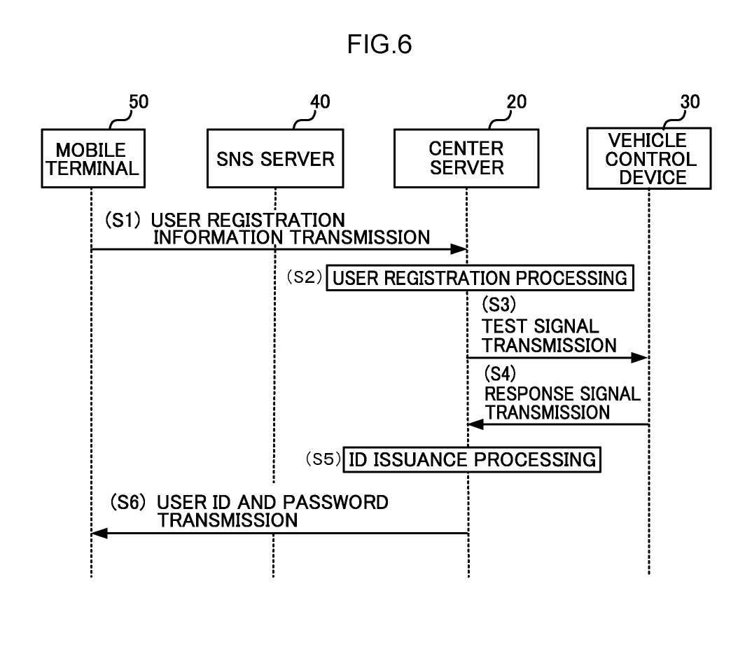

Next, with reference to the sequence diagram in FIG. 6, the flow of processing in the vehicle interior environment adjustment system 10 of the present embodiment will be described.

First, in the center server 20, processing required by a specific user being a user using the SNS, who desires to adjust the vehicle interior environment of the vehicle 12, will be described.

In step S1 in FIG. 6, the mobile terminal 50 transmits the user registration information input into the mobile terminal 50 toward the center server 20. Here, the user registration information is information input from the input device of the mobile terminal 50, and is transmitted to the center server 20 through an application installed in advance in the mobile terminal 50 or a dedicated internet site. The user registration information includes an account and a password necessary for viewing postings of a specific user in the SNS server 40, information for specifying the vehicle control device 30 (for example, a terminal-specific ID), information for specifying the mobile terminal 50 (for example, a terminal-specific ID), and the like.

In addition, as the user registration information, it is possible to register preference information regarding the vehicle interior environment such as the user's favorite tune, scent, and color. Specifically, tunes and sound volumes played in the vehicle interior can be registered for each of “pleasure” expressing the emotion of pleasure, “anger” expressing the emotion of anger, “sadness” expressing the emotion of sadness, and “calmness” expressing the emotion of calmness. Similarly, it is possible to register the scent in the vehicle interior, the lighting color, and the illumination for each type of emotion. The processing for registering the preference information related to the vehicle interior environment is executed in the setting unit 24 of the control unit 21. Specifically, the setting unit 24 writes the preference information for music, the preference information for scent, and the preference information for lighting acquired by the acquisition unit 22 in the first control table 26D, the second control table 26E, and the third control table 26F, respectively. It should be noted that the registration of preference information can also he changed even after user registration.

In step S2, the center server 20 executes user registration processing based on the user registration information acquired from the mobile terminal 50. Specifically, the setting unit 24 generates a unique user ID and writes the generated user ID and the acquired user registration information in a new area of the ID information table 26B.

In step S3, the center server 20 transmits a test signal toward the vehicle control device 30 of the terminal-specific ID included in the user registration information.

In step S4, when normally receiving the test signal, the vehicle control device 30 transmits a response signal toward the center server 20.

In step S5, when normally receiving the response signal, the center server 20 executes ID issuance processing. Specifically, the center server 20 acquires the user ID for user notification and the password generated at the same time as the ID from the ID information table 26B.

In step S6, the center server 20 transmits the user ID generated in the user registration processing and the password generated at the same time to the mobile terminal 50.

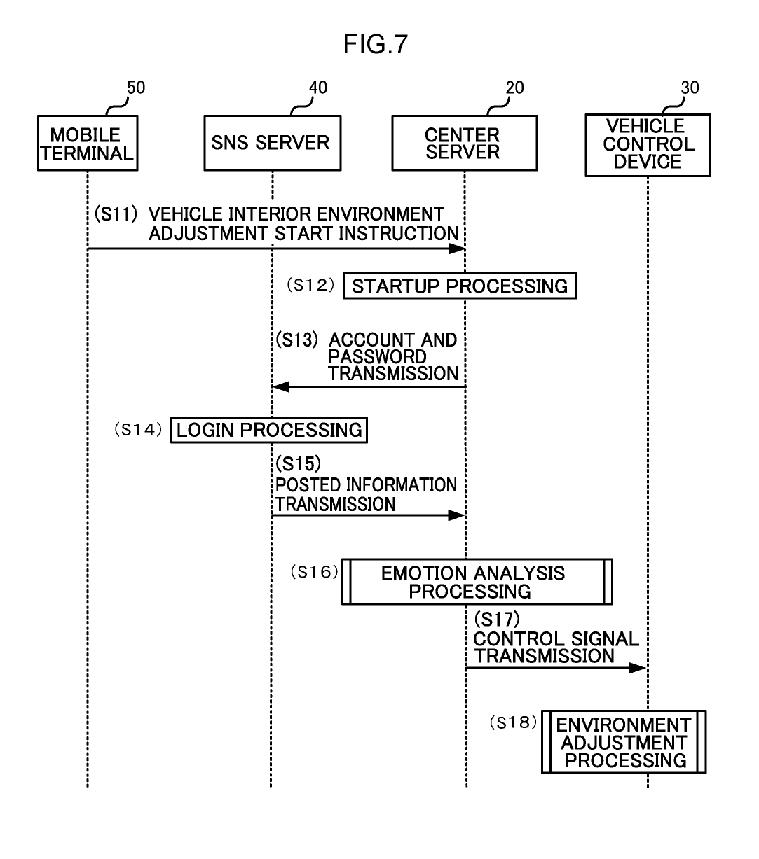

Next, with reference to the sequence diagram in FIG. 7, the processing when the vehicle interior environment is adjusted will be described.

In step S11 in FIG. 7, the mobile terminal 50 transmits vehicle interior environment adjustment start instructions to the center server 20 based on a predetermined operation by a specific user. It should be noted that the vehicle interior environment adjustment start instructions may be transmitted from the vehicle control device 30 based on a predetermined operation by a specific user.

In step S12, the center server 20 receiving the vehicle interior environment adjustment start instructions executes startup processing. Specifically, the control unit 21 of the center server 20 refers to the ID information table 26B to acquire the account and password of the SNS server 40 corresponding to the user ID.

In step S13, the communication unit 28 of the center server 20 transmits the account and password toward the SNS server 40.

In step S14, the SNS server 40 executes login processing by using the account and password received from the center server 20. In the SNS server 40, the account and the password coincide with each other, whereby the center server 20 can browse (that is, download) postings of the specific user.

In step S15, the SNS server 40 transmits posted information toward the center server 20. That is, the text information related to the posting is downloaded.

In step S16, the center server 20 executes emotion analysis processing. Details will be described below. Executing the emotion analysis processing classifies the characteristics related to the posting of the specific user, that is, the emotions of the specific user obtained from the posted contents into any one of the types. Then, the node of the vehicle interior environment corresponding to the classified type is determined.

In step S17, the center server 20 transmits the control signal related to the mode of the vehicle interior environment determined in step S16 from the communication unit 28 toward the vehicle control device 30.

In step S18, the vehicle control device 30 receiving the control signal adjusts the vehicle interior environment based on the control signal. Details will be described below

As described above, in the present embodiment, posting contents of the SNS can be reflected in the vehicle interior environment.

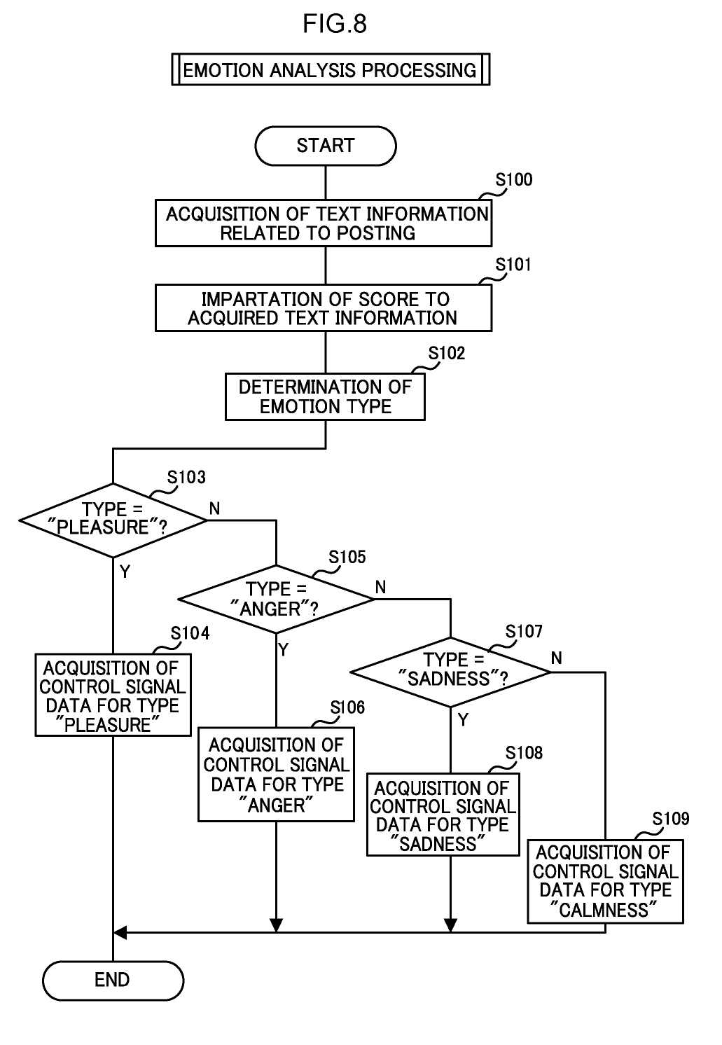

Next, with reference to FIG. 8, emotion analysis processing executed by the CPU 21A reading the execution program 26A in the center server 20 will be described.

First, in step S100, the acquisition unit 22 acquires postings of a specific user from the SNS server 40, that is, text information related to postings via the communication unit 28. Postings to be acquired may include postings within a certain period of time (for example, within 24 hours or within one week), a certain number of postings (for example, five postings in the past), and postings for specific contents or users.

In the next step S101, the determination unit 23 compares the acquired text information with the phrase set for each type of emotions, and imparts a score according to the degree of coincidence and the number of coincidences. For example, points of type “pleasure” are imparted to phrases strongly connected with pleasure such as “good condition” and “delicious”. In addition, points of type “anger” are imparted to phrases strongly connected with anger such as “mad” and “irritated”, Furthermore, points of type “sadness” are imparted to phrases strongly connected with sadness such as “farewell” and “death”.

In the next step S102, the determination unit 23 compares the score of each type related to the emotions, and classifies the type with the highest score as the emotion of the specific user. That is, the type of emotion of a specific user is determined.

In the next step S103, the determination unit 23 determines whether or not the classified type is “pleasure”, that is, whether or not the specific user has an emotion of pleasure. If the determination unit 23 determines that the type is “pleasure”, the process proceeds to the next step S104. On the other hand, if the determination unit 23 determines that the type is not “pleasure”, the process proceeds to step S105.

In step S104, the determination unit 23 refers to the environment table 26C and acquires the setting number of each element corresponding to the type “pleasure”. In addition, the determination unit 23 refers to the first control table 26D, the second control table 26E, and the third control table 26F, and acquires control signal data corresponding to each setting number. Then, the emotion analysis processing ends.

On the other hand, in step S105, the determination unit 23 determines whether or not the classified type is “anger”, that is, whether or not the specific user has an emotion of anger. If the determination unit 23 determines that the type is “anger”, the process proceeds to the next step S106. On the other hand, if the determination unit 23 determines that the type is not “anger”, the process proceeds to step S107.

In step S106, the determination unit 23 refers to the environment table 26C and acquires the setting number of each element corresponding to the type “anger”. In addition, the determination unit 23 refers to the first control table 26D, the second control table 26E, and the third control table 26F, and acquires control signal data corresponding to each setting number. Then, the emotion analysis processing ends.

On the other hand, in step S107, the determination unit 23 determines whether or not the classified type is “sadness”, that is, whether or not the specific user has an emotion of sadness. If the determination unit 23 determines that the type is “sadness”, the process proceeds to the next step S108. On the other hand, if the determination unit 23 determines that the type is not “sadness”, the process proceeds to step S109.

In step S108, the determination unit 23 refers to the environment table 26C and acquires the setting number of each element corresponding to the type “sadness”. In addition, the determination unit 23 refers to the first control table 26D, the second control table 26E, and the third control table 26F, and acquires control signal data corresponding to each setting number. Then, the emotion analysis processing ends.

Then, if the process proceeds to step S109, that is, if neither “pleasure”, “anger” nor “sadness” is applied, the determination unit 23 determines that the classified type is “calmness”, and refers to the environment table 26C to acquire the setting number of each element corresponding to the type “calmness”. in addition, the determination unit 23 refers to the first control table 26D, the second control, table 26E, and the third control table 26F, and acquires control signal data corresponding to each setting number. Then, the emotion analysis processing ends.

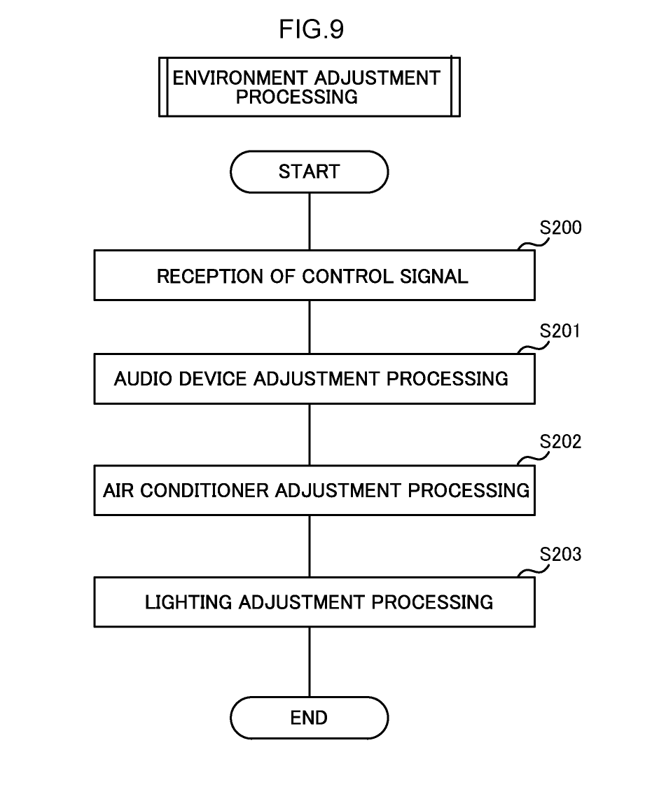

Next, with reference to FIG. 9, environment adjustment processing executed by the CPU 32A reading the control program 34A in the vehicle control device 30 will be described.

First, in step S200, the communication unit 36 of the vehicle control device 30 receives a control signal from the center server 20.

In the next step S201, the control unit 32 executes audio device adjustment processing. Specifically, the control unit 32 outputs a control signal toward the audio device 38A. Thus, the audio device 38A adjusts the mode of music of the vehicle interior environment. That is, the audio device 38A reproduces a tune corresponding to the classified emotion type at a predetermined sound volume level.

In the next step S202, the control unit 32 executes air conditioner adjustment processing. Specifically, the control unit 32 outputs a control signal toward the air conditioner 38. Thus, the air conditioner 38B adjusts the mode of scent of the vehicle interior environment. That is, the air conditioner 38B adds a scent corresponding to the classified emotion type to the air flow.

In the next step S203, the control unit 32 executes the lighting adjustment processing. Specifically, the control unit 32 outputs a control signal toward the lighting device 38C. Thus, the lighting device 38C adjusts the mode of lighting of the vehicle interior environment. In other words, the lighting device 38C lights the light source of the lighting color corresponding to the classified emotion type in a predetermined illumination. Then, the environment adjustment processing ends.

### Summary

As described above, according to the vehicle interior environment adjustment system 10 and the center server 20 of the present embodiment, it is possible to provide a vehicle interior environment comfortable for a specific user being an occupant of the vehicle 12 using posted information of the SNS. In addition, in the present embodiment, the determination unit 23 classifies emotions of a specific user, whereby it is possible to easily adjust the vehicle interior environment. In particular, the center server 20 can easily classify the characteristics of a specific user by acquiring the text information posted on the SNS and comparing the text information with the phrase set for each type a emotions. Then, in the present embodiment, the setting unit 24 allows the user side to set the mode of the vehicle interior environment corresponding to the type of emotions, whereby it is possible to reflect the preference of the specific user in the vehicle interior environment.

### Second Embodiment

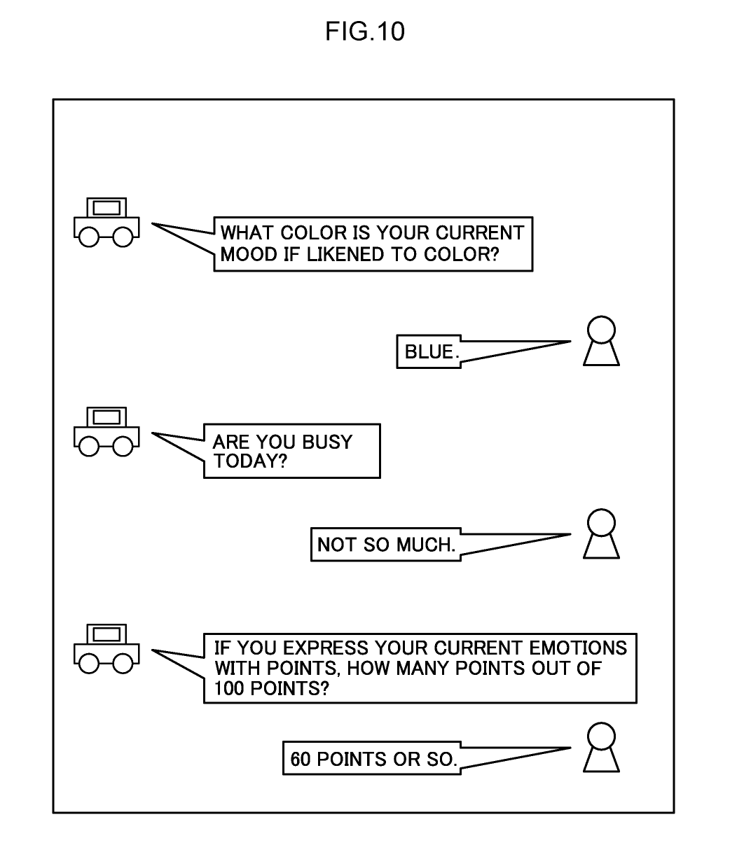

The vehicle interior environment adjustment system 10 of the first embodiment analyzes the emotion of a specific user based on posted information of the specific user already stored in the SNS server 40 and reflects this in the vehicle interior environment. On the other hand, as shown in FIG. 10, the vehicle interior environment adjustment system 10 of the second embodiment analyzes emotions of a specific user while causing the center server 20 and the specific user to have a dialogue on the SNS to reflect the analysis result in the vehicle interior environment.

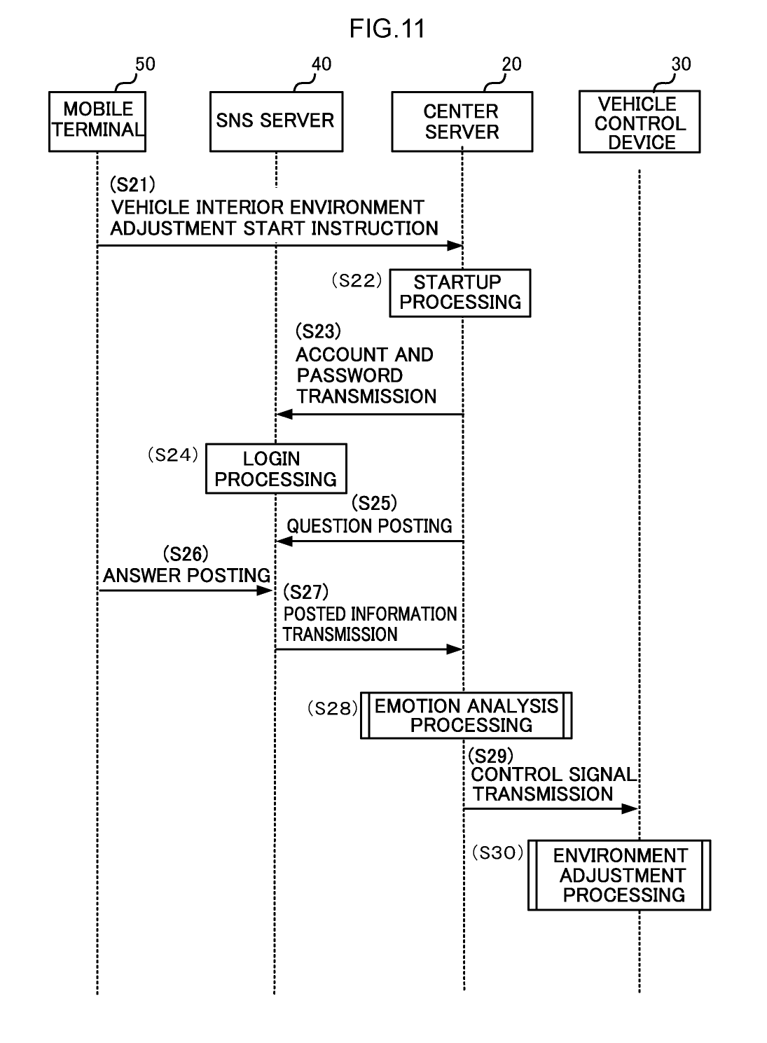

With reference to the sequence diagram in FIG. 11, the flow of processing in the vehicle interior environment adjustment system 10 of the present embodiment will be described. It should be noted that the configuration of the vehicle interior environment adjustment system 10 of the second embodiment is the same as that of the first embodiment, and a description, thereof will be omitted.

The processing from step S21 to step S24 in FIG. 11 is the same as the processing from step S11 to step S14 in FIG. 7, and description thereof will be omitted.

In step S25, the center server 20 posts a question to a specific user to the SNS server 40. Specifically, the output unit 25 of the center server 20 transmits the text information to be posted to the SNS server 40. The text information is data stored in the storage unit 26. For example, as shown in FIG. 10, questions suitable for grasping emotions, such as “What color is your current mood if likened to color?”, “Are you busy today?”, and “If you express your current emotions with points, how many points out of 100 points?”, are transmitted as text information.

In step S26 in FIG. 11, the mobile terminal 50 posts an answer to the question for the specific user to the SNS server 40. Specifically, the mobile terminal 50 transmits text information to be posted toward the SNS server 40. This text information is data related to a character string input by a specific user via the input unit of the mobile terminal 50. For example, as shown in FIG. 10, an answer of “Blue,” in response to the question “What color is your current mood if likened to color?”, an answer of “Not so much.” in response to the question “Are you busy today?”, an answer of “60 points or so.” in response to the question “If you express your current emotions with points, how many points out of 100 points?”, and the like, which are posted by the center server 20, are transmitted as text information.

In step S27 in FIG. 11, the SNS server 40 transmits posted information toward the center server 20. That is, the SNS server 40 transmits the text information related to the question posted by the center server 20 and the text information related to the answer thereto posted by the specific user using the mobile terminal 50. It should be noted that the text information related to the question and the text information related to the answer may be transmitted each time a posting is posted.

Hereinafter, the processing from step S28 to step S30 in FIG. 11 is the same as the processing from step S16 to step S18 in FIG. 7, and description thereof will be omitted.

As described above, according to the vehicle interior environment adjustment system 10 and the center server 20 of the present embodiment, effects similar to those of the first embodiment can be obtained. In addition, in the present embodiment, it is characterized in that a specific user has a dialogue with the center server 20 on the SNS. In particular, the center server 20 can accurately classify the emotions of specific users by posting questions to which specific users can easily express emotions to the SNS server 40. In addition, as compared with the case where the vehicle interior environment is adjusted by using postings to the SNS in the past, it is possible to reflect the current emotions in the vehicle interior environment.

### Third Embodiment

In the vehicle interior environment adjustment system 10 according to the first and second embodiments, the center server 20 executes emotion analysis processing, and the vehicle control device 30 executes environment adjustment processing. On the other hand, in the vehicle interior environment adjustment system 100 according to the third embodiment, the vehicle control device 130 is formed to execute both emotion analysis processing and environment adjustment processing.

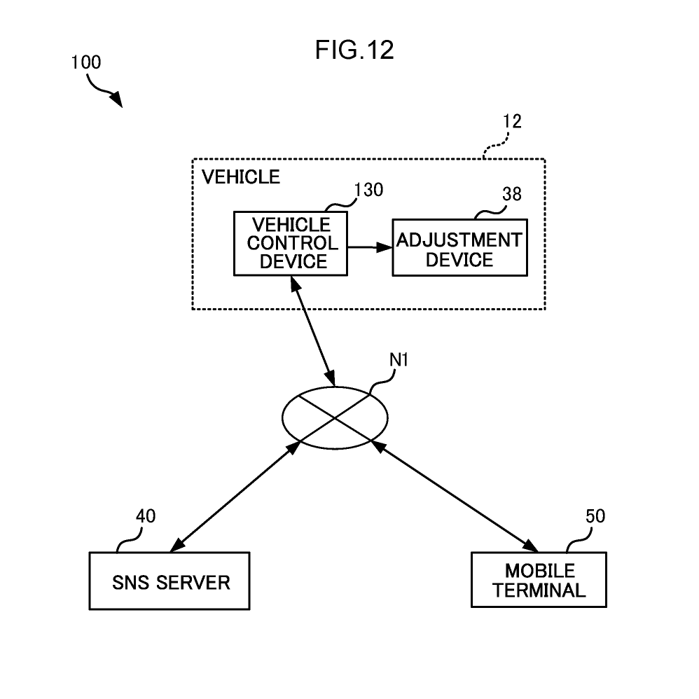

As shown in FIG. 12, the vehicle interior environment adjustment system 100 according to the present embodiment includes a vehicle 12, an SNS server 40, and a mobile terminal 50. That is, unlike the first and second embodiments, the present embodiment does not require a center server. In the following, differences from the first and second embodiments will be described. In addition, the same configurations as those of the first and second embodiments are denoted by the same reference numerals, and repeated description is omitted.

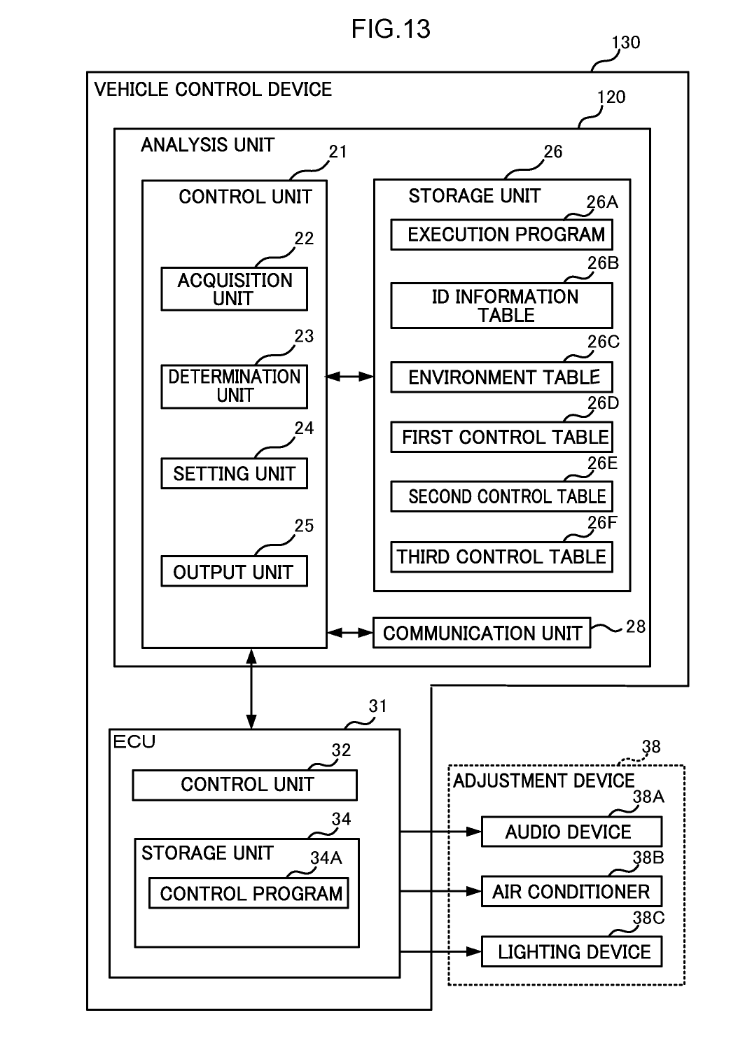

As shown in FIG. 12, the vehicle 12 includes a vehicle control device 130 being a control device and an adjustment device 38. As shown in FIG. 13, the vehicle control device 130 includes an ECU 31 and an analysis unit 120 The analysis unit 120 includes a control unit 21, a storage unit 26, and a communication unit 28. In the present embodiment, the analysis unit 120 corresponds to a vehicle interior environment adjustment device. It should be noted that in the present embodiment, the ECU 31 and the analysis unit 120 may be integrally formed.

In the present embodiment, communication between the analysis unit 120 and the SNS server 40 is performed via the communication unit 28. The analysis unit 120 has a function of acquiring posted information of a specific user from the SNS server 40 and analyzing characteristics of the specific user based on the acquired posted information. In addition, the analysis unit 120 has a function of determining the mode of the vehicle interior environment based on the analyzed characteristics and outputting a control signal related to the mode toward the ECU 31. Specifically, the output unit 25 outputs a control signal toward the ECU 31.

In the vehicle control device 130 configured as described above, both the emotion analysis processing and the environment adjustment processing are completed in the vehicle 12. Then, according to the present embodiment, it is possible to obtain the same action and effect as those of each of the above-described embodiments.

### Other Embodiments

In the first and second embodiments, the vehicle interior environment adjustment start instruction transmitted from the mobile terminal 50 is a moment for adjustment in each device of the adjustment device 38 (see FIGS. 7 and 11), but the moment for transmission is not limited to this. For example, as another embodiment, the case where the mobile terminal 50 registered in the center server 20 is present in the vehicle interior of the vehicle 12 may be used as a moment for adjustment. Here, as a method for detecting whether or not the mobile terminal 50 is present in the vehicle interior of the vehicle 12. Near Field Communication such as Bluetooth (registered trademark), a global positioning system (GPS), and the like can be used.

For example, in the case of using Near Field Communication, each of the mobile terminal 50 and the vehicle control device 30 includes a near field communication device, and when communication between the mobile terminal 50 and the vehicle control device 30 is established in the vehicle interior of the vehicle 12, it is possible to determine that the mobile terminal 50 is present in the vehicle interior. Here, when the mobile terminal 50 determines that the mobile terminal 50 is present in the vehicle interior, the vehicle interior environment adjustment start instruction is transmitted from the mobile terminal 50 to the center server 20. In addition, when the vehicle control device 30 determines that the mobile terminal 50 is present in the vehicle interior, the vehicle interior environment adjustment start instruction is transmitted from the vehicle control device 30 to the center server 20.

In addition, for example, when GPS is used, each of the mobile terminal 50 and the vehicle control device 30 includes a GPS device, and when the mobile terminal 50 is present within a certain area centered on the vehicle 12, it is possible to determine that the mobile terminal 50 is present in the vehicle interior. Here, when the mobile terminal 50 receives the positional information on the vehicle control device 30 and determines the presence of the mobile terminal 50 in the vehicle interior, the vehicle interior environment adjustment start instruction is transmitted from the mobile terminal 50 to the center server 20. In addition, when the vehicle control device 30 receives the positional information on the mobile terminal 50 and determines the existence of the mobile terminal 50 in the vehicle interior, the vehicle interior environment adjustment start instruction is transmitted from the vehicle control device 30 to the center server 20. Furthermore, when the center server 20 receives the positional information from each of the vehicle control device 30 and the mobile terminal 50 and determines the presence of the mobile terminal 50 in the vehicle interior, each piece of processing such as emotion analysis processing is executed without requiring a vehicle interior environment adjustment start instruction.

As described above, according to another embodiment, the center server 20 transmits a control signal toward the vehicle control device 30 when the mobile terminal 50 is present in the vehicle interior of the vehicle 12. Thus, it is possible to adjust the vehicle interior environment at the timing when a specific user holding the mobile terminal 50 rides in the vehicle 12.

### Others

In each of the above embodiments, emotions are classified as the characteristic of a specific user, but the characteristic that can be classified is not limited to emotion.

For example, “physical condition” may be classified as the characteristic of a specific user. Specifically, in the environment table 26C, the physical condition of a specific user is classified into a plurality of types such as a good condition state indicating good condition, a fatigue state indicating slight fatigue a hunger state indicating slight hunger, and a disease state indicating a slight cold or pollen allergy. Then, the determination unit 23 classifies the physical condition from the posted contents, the posting time, and the like of the SNS, whereby energetic music can be played in a fatigue state after night shift and mint scent can be emitted in a disease state of pollen allergic symptoms. That is, the adjustment device 38 can adjust the vehicle interior environment based on the physical condition of the specific user.

In addition, for example, an “attribute” may be classified as the characteristic of a specific user. Specifically, in the environment table 26C, the attribute of a specific user is classified into a plurality of types such as “group” representing a group. “couple” representing lovers or a couple, “child” representing “accompanied by a child”, and “single” indicating one-person ride. Then, the determination unit 23 classifies the attributes from, the posted contents, posting time, and the like of the SNS, whereby it is possible to play animation songs when moving with children and to wrap the vehicle interior with soft light when lovers move together. That is, the adjustment device 38 can adjust the vehicle interior environment based on the attribute of the specific user.

Then, for the characteristic of a specific user, any one of emotion, physical condition, and attributes may be used, or a combination of these may be used.

In each of the above embodiments, the adjustment device 38 includes an audio device 38A, an air conditioner 38B, and a lighting device 38C, and adjusts music, scent, and lighting as the vehicle interior environment, but the elements of the adjustable vehicle interior environment are not limited to these. For example, by adding temperature to the elements of the adjustable vehicle interior environment, the air conditioner 38B may adjust the vehicle interior temperature based on the characteristics of the specific user.

In addition, for example, the adjustment device 38 may include a measuring instrument such as a meter, whereby the color and font of the meter panel may be changed based on the characteristics of the specific user. In addition, for example, the adjustment device 38 may include a car navigation system, whereby the display method of the map and the type of the voice of the voice guide may be changed based on the characteristics of the specific user. In addition, for example, the adjustment device 38 may include a seat, whereby the height, angle, or seat arrangement of the seat may be adjusted based on the characteristics of the specific user.

It should be noted that in each of the above embodiments, the ECU 31 directly controls each of the adjustment devices 38, but is not limited thereto, and a dedicated ECU may be provided for each device configuring the adjustment device 38, and the ECU 31 may control each adjustment device 38 via a corresponding dedicated ECU.

In each of the above embodiments, only emotion classification of a specific user is performed in emotion analysis processing, but this is not limited, and a level indicating the degree of emotion may be determined based on the score imparted in step S101 in FIG. 8. Thus, the level can be reflected in the vehicle interior environment in addition to the classified emotion type. For example, when the emotion type is classified as “anger”, as the level of anger is increased, the volume of music can be turned up, the scent can be increased, and the illumination of the lighting can be increased.

In each of the above embodiments, the posting of SNS to be acquired is limited to text information, but is not limited to this, and image information such as photographs and moving images and voice information such as voice memos may be acquired, whereby emotion analysis processing may be performed based on this. For example, when emotion analysis processing is performed based on posting of a photograph, the emotion type can be classified based on the content and color tone of the image included in the photograph. In addition, for example, when emotion analysis processing is performed based on posting of a voice memo, the emotion type can be classified based on the voice tone.

It should be noted that in the first and second embodiments, the center server 20 is exemplarily described as the vehicle interior environment adjustment device, and in the third embodiment, the analysis unit 120 included in the vehicle control device 130 is exemplarily described as the vehicle interior environment adjustment device. Each embodiment may be in the form of a program for causing a computer to execute the functions of the respective units included in each of the center server and the analysis unit. The embodiment may be in the form of a non-transitory computer-readable storage medium storing this program.

In addition, in the above embodiments, the case where executing a program causes processing related to the embodiment to be achieved by software configuration using a computer is described, but the present disclosure is not limited to this. The embodiment may be achieved by, for example, a hardware configuration or a combination of a hardware configuration and a software configuration.

In addition, the flow of processing described in the above embodiments is also an example, and unnecessary steps may be deleted, new steps may be added, or the processing order may be replaced within the scope not deviating from the gist.

In addition, the configuration of each of the management servers and terminal devices described in the above embodiments is an example, and may be changed depending on the situation within the scope not deviating from the gist.

What is claimed is:

1. A vehicle interior environment adjustment device, comprising:
a first memory; and
a first processor connected to the first memory, wherein the first processor:
acquires posted information, posted by a specific user, from a management server configured to manage a social networking service (SNS),
determines a mode of a vehicle interior environment of a vehicle in which the specific user rides, from a characteristic of the specific user based on the acquired posted information, and
outputs a control signal according to the determined mode.

2. The vehicle interior environment adjustment device according to claim 1, wherein the first processor:
classifies, by type, the characteristic of the specific user from the acquired posted information, and
determines the mode based on the classified type.

3. The vehicle interior environment adjustment device according to claim 2, wherein:
the posted information is text information, and
when the text information includes a phrase related to each type, the first processor classifies a type corresponding to the phrase as the characteristic of the specific user, and determines the mode based on the classified type.

4. The vehicle interior environment adjustment device according to claim 2 wherein, in the first processor, the mode corresponding to the type is set by the specific user.

5. A non-transitory storage medium storing a program for causing a first processor to execute interior environment adjustment processing, the interior environment adjustment processing comprising:
acquiring posted information, posted by a specific user, from a management server configured to manage a social networking service (SNS);
determining a mode of a vehicle interior environment of a vehicle in which the specific user rides, from a characteristic of the specific user based on the acquired posted information; and
outputting a control signal according to the determined mode.

6. The non-transitory storage medium storing a program according to claim 5, the interior environment adjustment processing further comprising:
classifying, by type, the characteristic of the specific user from the acquired posted information, and
determining the mode based on the classified type.

7. The non-transitory storage medium storing a program according to claim 6, wherein:
the posted information is text information, and
when the text information includes a phrase related to each type, the interior environment adjustment processing comprises:
classifying a type corresponding to phrase as the characteristic of the specific user, and
determining the mode based on the classified type.

8. The non-transitory storage medium storing a program according to claim 6, wherein, in the interior environment adjustment processing, the mode corresponding to the type is set by the specific user.

9. A vehicle interior environment adjustment system, comprising:
the vehicle interior environment adjustment device according to claim 1 and a vehicle configured to receive the control signal from the vehicle interior environment adjustment device, wherein the vehicle includes:
an adjustment device configured to adjust the vehicle interior environment,
a second memory, and
a second processor connected to the second memory,
wherein the second processor controls the adjustment device base on the control signal acquired from the vehicle interior environment adjustment device.

10. A vehicle interior environment adjustment system, comprising:
the vehicle interior environment adjustment device according to claim 1;
a mobile terminal registered in the vehicle interior environment adjustment device; and
a vehicle configured to receive the control signal from the vehicle interior environment adjustment device,
wherein the vehicle includes:
an adjustment device configured to adjust the vehicle interior environment, and
a control device configured to control the adjustment device,
wherein the control device includes:
a second memory, and
a second processor connected to the second memory,
wherein the first processor transmits the control signal toward the control device when the mobile terminal is present in a vehicle interior of the vehicle, and
wherein the second processor controls the adjustment device based on the control signal acquired from the vehicle interior environment adjustment device.
